(19) United States
(12) Patent Application Publication
(10) Pub. No.: US 2003/0055895 A1
(43) Pub. Date: Mar. 20, 2003

(54) Internet based system designer with live agent assist

(76) Inventor: Charles A. Peters, St. Louis, MO (US)

Correspondence Address: HARNESS, DICKEY & PIERCE, P.L.C., P.O. BOX 828, BLOOMFIELD HILLS, MI, 48303, US

(21) Appl. No.: 09/940,100

(22) Filed: Aug. 27, 2001

(51) Int. Cl. G06F 15/16

(52) U.S. Cl. 709/205

(57) ABSTRACT

An Internet based system designer with live agent assist is disclosed. In one aspect the system design comprises a configurator tool providing a range of relationships for correlating selections within a scope of a configuration and a common reference frame in communication with a configurator tool whereby a user of a configurator tool and a live agent simultaneously view at least one common page. In one respect, the configurator tool comprises an expert system and a live agent assists the user by helping the user to perform navigation of the expert system and/or use of the expert system. Live agent assistance is facilitated where the user and the live agent establish mutual communication. In one embodiment, the mutual communication occurs by means of digital data link. In another respect, the live agent assists the user in modification of at least one of a selection, a relationship, a configuration, a configurator tool, the mutual communication, a common reference frame, and a common page. In a further aspect, the modification of the configuration may include expansion, limitation, and/or redefinition of a scope of the configuration. With regard to this further aspect, multiple configurator tools may be employed.

### FIELD OF THE INVENTION

The present invention relates generally to e-commerce systems and in particular to web based configurator software tools.

### BACKGROUND AND SUMMARY OF THE INVENTION

The world wide web, and other information and communication facilities of the internet, have opened doors to a number of interesting business support applications. Initially, the internet served simply as a vehicle to disseminate information about a company's products and services, and to assist customers in selecting those products and services for purchase. Software systems, known as selection tools, evolved to support these simple selection functions.

However, more recently, sophisticated companies have begun using the internet to support complex products and services, and to assist customers in making complex purchasing and configuration decisions. Such functions go far beyond simple product selection. After items are selected, the relationships and interactions among those selected items are taken into account. Software systems known as configuration tools or “configurator” tools, have evolved to fulfill this purpose. In assessing relationships, configurator tools may employ both look-up and algorithmic processes.

By way of illustration, consider the product selection tool first. The typical product selection tool presents an on-screen catalog of products with an interactive interface through which the customer can add or subtract options. In shopping for a new computer, for example, the customer can make such option selections as adding or subtracting a modem, increasing or decreasing the memory and disk storage size, selecting a larger or smaller monitor, and the like.

In contrast, the configurator tool does considerably more. While it can be used to present on-screen information about products, services and selection options, the configurator tool also allows the user to alter parameters, combine components in user-defined ways, and to define the architecture and attributes of systems that may uniquely fit the user's needs.

For example, a configurator tool might be used to assist an engineer in designing the layout and components deployed in a petroleum refinery plant or an electric generating plant. Such applications would typically involve far more than simply selecting components. Complex physical, chemical, and electrical interactions also can be taken into account. Special attributes of individual components, such as their capacity, operating ratings, and physical characteristics also can be taken into account.

As the above example suggests, configurator tools can be quite complex. Often they may employ one or more expert systems or other artificial intelligence components to capture knowledge that is then presented to the user as needed. Unfortunately, there seems to be an inverse relationship between power and ease of use. The more powerful a configurator tool becomes, the more difficult it is to use.

As many web system designers have experienced, it is fairly easy to design an intuitive, self-directed tool when that tool must only access a shallow pool of knowledge. It becomes geometrically more difficult to retain the intuitive, self-directed properties as the knowledge pool deepens. Stated differently, as the body of knowledge encapsulated by the system grows, self-directed navigation through the system becomes increasingly more difficult.

The present invention tackles this problem with live agent technology. The expert system and other artificial intelligence components of the configurator tool are integrated with a live agent support system that places the user in communication with live agents (e.g. human assistants) as needed. While the user can navigate through and use the configurator tool alone, the user can also obtain on-the-spot assistance from a live agent simply by asking via onscreen selection. The live agent support system defines a common reference frame through which the user and agent communicate. While the common reference frame can take many forms, some of the presently preferred embodiments employ internet chat facilities for messaging and push technology to allow the agent to supply content to the user or to control what the user experiences at his or her web browser.

By solving the basic tool navigation problem, the invention makes complex configurator tools far easier to develop and use. In a typical implementation, the live agent works with the configurator tool every day, assisting users in solving ad hoc problems. Thus, while the agent may not necessarily be an expert in the underlying knowledge base for which the configurator tool was designed (e.g. instrumentation and control design, power system design, closet design), the agent does become an expert in using the tool. Thus when a user is blocked due to unfamiliarity with the tool, the live agent can step in to assist. This is a significant improvement that system users will readily appreciate.

However, from a business standpoint, the live agent support component of the invention offers an even more significant advantage. It places live agents in direct communication with customers, on the customers' own invitation. Direct marketing experts have long recognized the value of customer invitation. The potential customer who has given permission to be contacted directly represents a far better prospect than the one whose name simply appears on a purchased mailing list. The live agent support component of the invention thus places the live agent and potential customer (system user) in a permissive relationship that gives the live agent the opportunity to upsell, cross sell, and to establish a future relationship with that user as a customer.

In one aspect the system designer comprises a configurator tool providing a range of relationships for correlating selections within a scope of a configuration and a common reference frame in communication with a configurator tool whereby a user of a configurator tool and a live agent simultaneously view at least one common page. In one respect, the configurator tool comprises an expert system and a live agent assists the user by helping the user to perform navigation of the expert system and/or use of the expert system. Live agent assistance is facilitated where the user and the live agent establish mutual communication. In one embodiment, the mutual communication occurs by means of Internet chat technology. In another respect, the live agent assists the user by means of modification of at least one of a selection, a relationship, a configuration, a configurator tool, the mutual communication, a common reference frame, and a common page. In a further aspect, the modification of the configuration may include expansion, limitation, and/or redefinition of a scope of the configuration. With regard to this further aspect, multiple configurator tools may be employed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a relationship diagram for the Internet based system designer with live agent assist.

FIG. 2 is an information flow outline of the mutual communication between the user and the live agent.

FIG. 3 is a relationship diagram depicting a live agent expanding the scope of a configurator tool by adding selections and relationships not within the scope of the configurator tool.

FIG. 4 is a relationship diagram depicting a live agent bridging the gap between configurator tools to create a multiple configurator tool system.

FIG. 5 is a flow chart depicting a method of selecting a live agent.

FIG. 6 is a world map depicting literacy by region.

FIG. 7 is a world map depicting income level by region.

### DETAILED DESCRIPTION OF THE PREFERRED EMBODIMENTS

The following description of the preferred embodiment(s) is merely exemplary in nature and is in no way intended to limit the invention, its application, or uses.

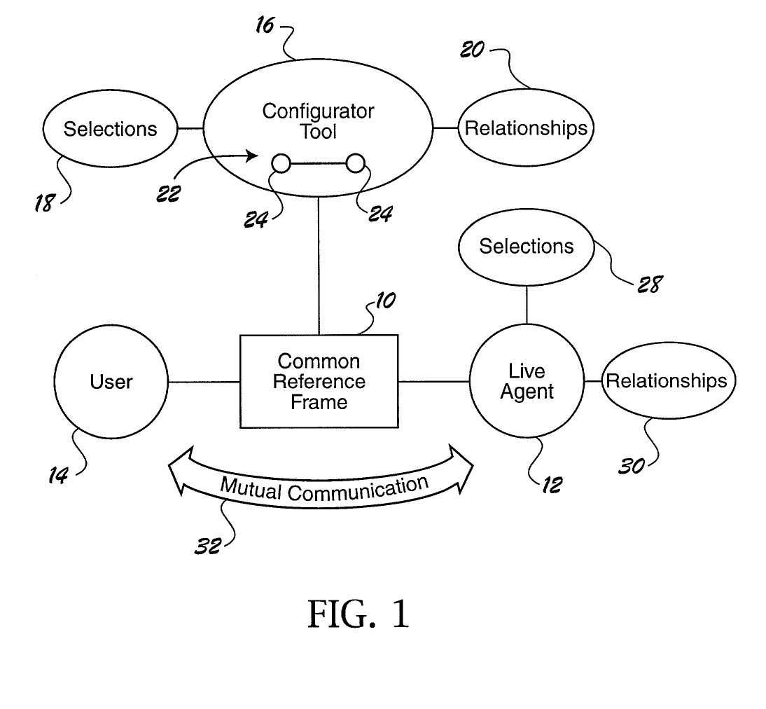

The Internet based system designer with live agent assist focuses on helping the user navigate and use a configurator tool. Referring now to FIG. 1, a relationship diagram for the Internet based system design is shown. The crux of the system design is a common reference frame 10 which in a preferred embodiment is a user interface permitting a live agent 12 to simultaneous view the same web pages as a user 14. The common reference frame 10 reflects changes entered by the user 14 and allows the live agent 12 to push pages at the user 14. Thus, the live agent 12 assists the user 14 in the navigation and use of a configurator tool 16. As shown in FIG. 1, the configurator tool 16 has a domain of selections 18 and a range of relationships 20 for constructing a configuration 22. A configuration 22 is formed when individual selections 24 are correlated by a common relationship 26. Sample individual selections 24 within a domain of selections 18 for a particular configurator tool 16 might be components of a computer system all made by the same manufacturer. In such a case the range of relationships 20 for the particular configurator tool 16 might be particular component characteristics, requirements, and compatibility. In another example, a configurator tool 16 for designing a custom closet space might have a domain of selections 18 including closet features such as shelving units, shoe trees, tie racks, and storage compartments. For such a particular configurator tool 16 the range of relationships 20 might include space requirements, storage capability, and placement characteristics. In still a further example, a particular configurator tool 16 might focus on designing instrumentation and control layout. The domain of selections 18 for such a particular configurator tool 16 might include such components as intelligent field devices, standards and platforms, and integrated modular software. For such a particular configurator tool 16 the range of relationships 20 might include fluid flow requirements for a particular component as well as fluid flow characteristics of another component. A live agent 12 having a common reference frame 10 with a user 14 may push pages at the user 14 through the common reference frame 10 in an attempt to upsell and cross sell a particular component to a user 14. However, in order for a user 14 to benefit from the additional domain of selections 28 and additional domain of relationships the live agent 12 possesses through specialized knowledge, it is preferable for the live agent 12 and the user 14 to establish mutual communication 32. In a preferred embodiment the live agent 12 and the user 14 establish mutual communication 32 regarding a common reference frame 10 by means of a digital data link. It is foreseeable that the mutual communication 32 may be accomplished by various and other means such as Internet chat technology, an online instant messaging system, digital audio link, digital video link, or a telephone, to name a few. The digital data link, however, is preferred in that it allows the user to stay online and engaged in the process of configuration during the course of the mutual communication 32.

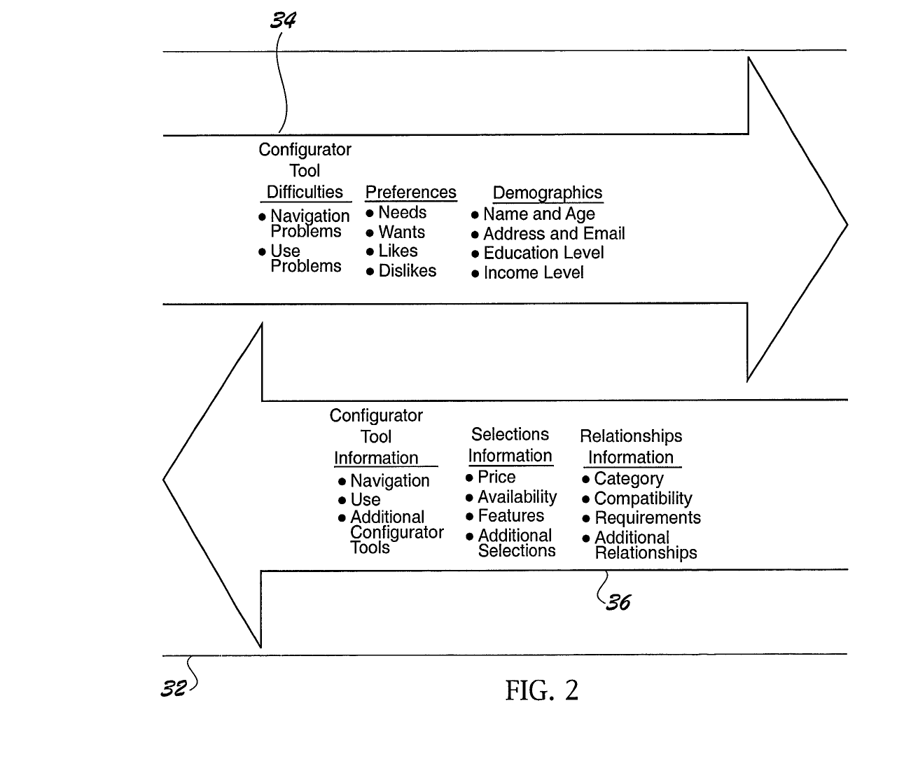

Referring now to FIG. 2, an information flow outline of the mutual communication 32 is shown. In FIG. 2 user information 34 is communicated from the user 14 to the live agent 12. Examples of user information include configurator tool difficulties, preferences, and demographics. Examples of configurator tool difficulties include navigation problems and use problems. Examples of preferences include needs, wants, likes, and dislikes. Examples of demographics includes name and age, address and email, education level, and income level. In response to the user communication 34, FIG. 2 depicts agent communication 36 from the live agent 12 (FIG. 1) to the user 14 (FIG. 1). Examples of agent communication 36 includes configurator tool information, selections information, and relationships information. Examples of configurator tool information include navigation information, use information, and information concerning additional configurator tools. Examples of use information, such as configurator tool utilities, include testing of application limits and conformance to specification. Examples of selections information include price, availability, features, and additional selections. Examples of relationships information include category, compatibility, requirements, and additional relationships.

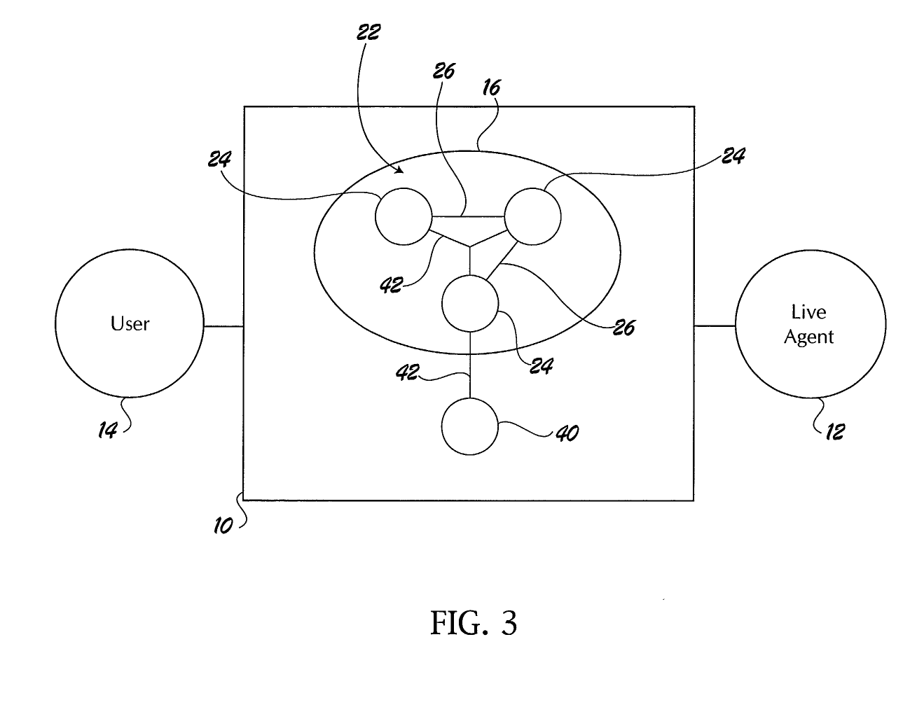

Referring now to FIG. 3, a configuration 22 formed by the configurator tool 16 is conceptually displayed from the perspective of the live agent 12 and the user 14 within the common reference frame 10. Individual selections 24 from the domain of selections 18 (FIG. 1) are displayed as correlated by common relationships 26 from within the range of relationships 20 (FIG. 1) possessed by the configurator tool 16. Together the domain of selections 18 (FIG. 1) and the range of relationships 20 (FIG. 1) of the configurator tool 16 form a scope of the configurator tool 16. As shown in FIG. 3, the live agent 12 has modified the scope of the configurator tool 16 through supplementation with an additional individual selection 40 and additional common relationships 42. The additional individual selection 40 originates from the additional domain of selections 28 (FIG. 1) and similarly the additional common relationships 42 originate from the additional range of relationships 30 (FIG. 1). As an example, consider that a particular configurator tool 16 in which individual selections 24 might therefore be individual components of a personal computer system while the common relationships 26 might be information concerning compatibility and requirements of the individual components. The individual selections 24 might be personal computer system components for a particular manufacturer, and as a result, the user 14 might wish to configure these components with another component of another manufacturer that the user 14 already has in his or her possession. The particular component of another manufacturer, therefore, constitutes an additional individual selection 40 which is not within the scope of the configurator tool 16. The user 14 therefore, communicates a preference for the additional individual selection 40 via user communication 34 (FIG. 2) by means of the mutual communication 32 (FIG. 2). The live agent 12 may therefore supplement the configurator tool 16 with the additional individual selection 40 from within the additional domain of selections 28 (FIG. 1). Similarly, the live agent 12 may supplement the configurator tools 16 with additional common relationships 42 from within the additional range of relationships 30 (FIG. 1) such as compatibility and requirements for the additional individual selection 40. In this example, the personal computer system component of the other manufacturer may be compatible with the configuration 22 assembled by the configurator tool 16. As an additional example, the user 14 may communicate a preference via user communication 34 (FIG. 2) by means of mutual communication 32 (FIG. 2) to the live agent 12 regarding a need to remain within a particular budget. As a result, the live agent 12 may supplement the configurator tool 16 with additional common relationships 42 so as to achieve an optimal configuration 22 for the user 14 based on the need to remain within a particular budget.

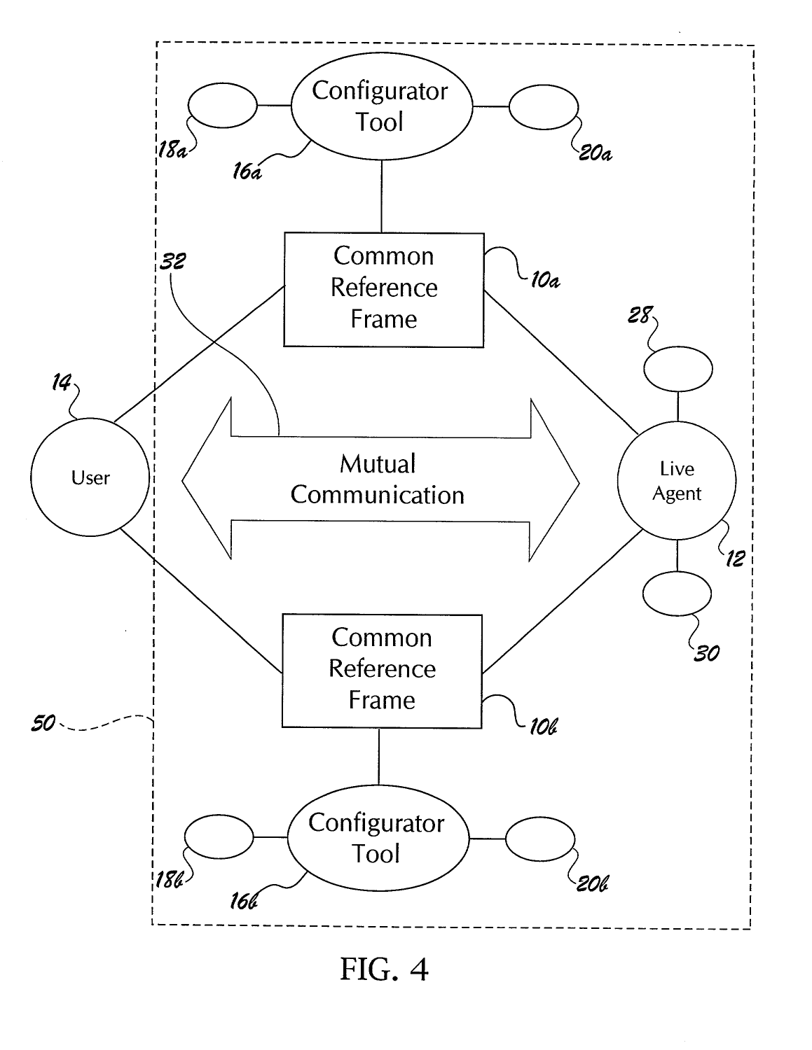

Referring now to FIG. 4, a depiction of a live agent 12 implementing a configurator tool system 50 is shown. In the configurator tool system 50 of FIG. 4, the live agent 12 uses a common reference frame 10a and a common reference frame 10b. Common reference frame 10a is in communication with configurator tool 16a and, similarly, common reference frame 10b is in communication with configurator tool 16b. Configurator tool 16a provides a domain of selections 18a and a range of relationships 20a. Similarly, configurator tool 16b provides a domain of selections 18b and a range of relationships 20b. Live agent 12 provides an additional domain of selections 28 and an additional range of relationships 30 by virtue of specialized knowledge. As preferred, the live agent 12 and the user 14 maintain mutual communication 32. It may be that common reference frame 10a and common reference frame 10b are identical, however, configurator tool 16a and configurator tool 16b should be understood as distinguishable. As one example, consider a configurator tool 16 for designing a closet. Also consider a configurator tool 16 for designing a kitchen. Also consider a configurator tool 16 for designing a living room. Also consider other configurator tools for designing various rooms within a home. The live agent 12 may assist the user 14 by bridging the gap between each configurator tool 16 to form a configurator tool system 50 for designing the interior of a home. While it is foreseeable that software tools may develop configurator tool systems 50 comprising more than one configurator tool 16, live agent assistance will further supplement such a configurator tool system 50 in a manner consistent with the present invention. A configurator tool 16 for deck design, for example, may be joined with the configurator tool system 50 for designing the interior of a home by means of the live agent to comprise a configurator tool system 50 for designing a home.

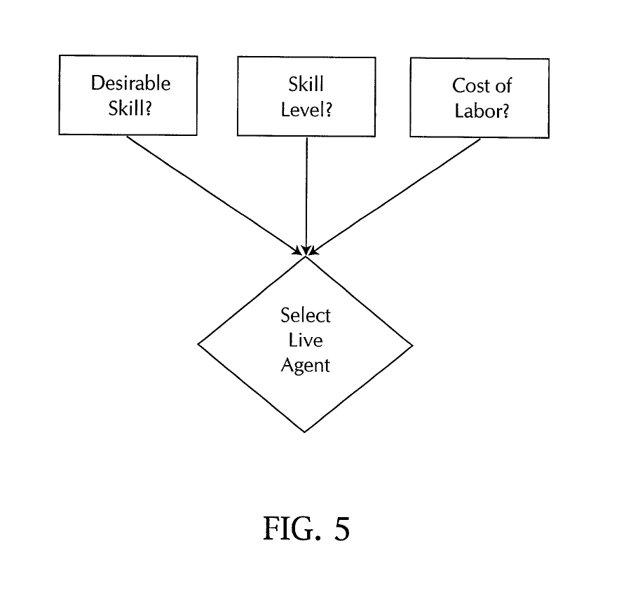

Referring now to FIG. 5, a flow chart depicting an agent selection method is shown. As depicted, it is necessary to determine at least one desirable skill required of the live agent, to determine an appropriate level of skill required of the live agent, and to evaluate the cost of labor for at least one live agent, and then select the live agent based, at least in part, on the cost of labor for a live agent with the appropriate level of skill regarding the desirable skill. As may be expected, some skills will be commonly desired for any live agent 12 (FIG. 1) chosen to provide assistance to an Internet based system designer. An example of such a skill would be the ability to read and write, while further examples of such skills include facility with a computer, interaction skills, and technical training regarding specifics of the applications.

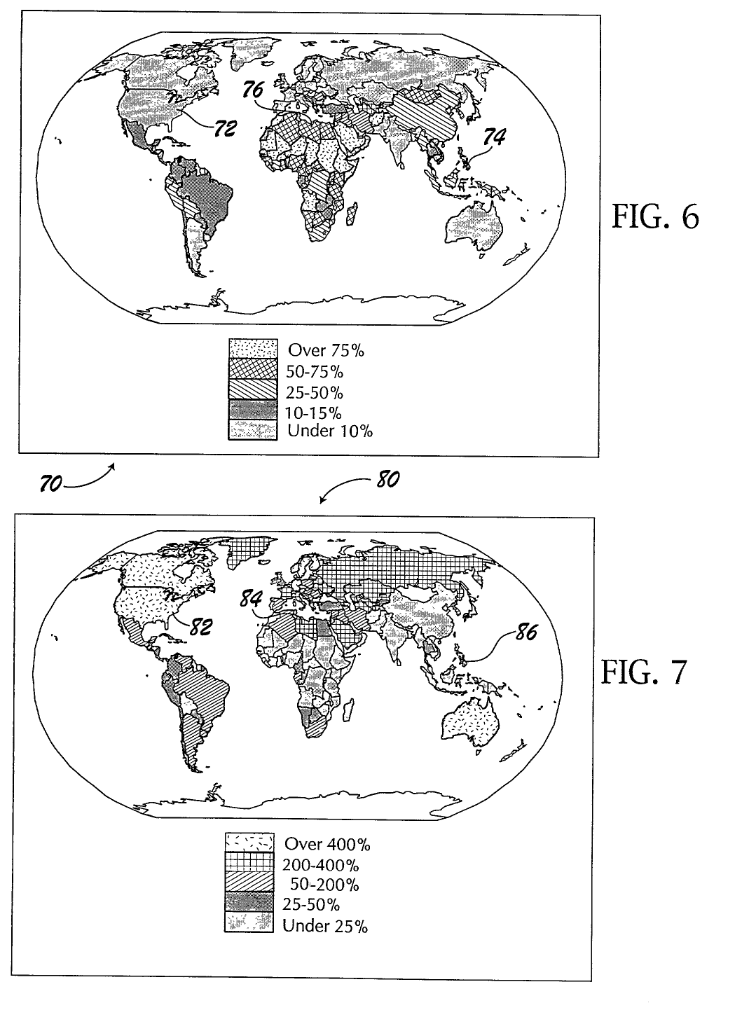

Referring now to FIG. 6, a world map depicting literacy by region 70 is shown. A region of high literacy 72 is shown. In this case the region of high literacy 72 is the United States of America where the percentage of the adult population unable to read or write is under ten percent. Also, a region of relatively high literacy 74 is shown. In this case, the region of relatively high literacy 74 is the Philippines where the percentage of the adult population unable to read or write is ten to fifteen percent. Also shown is a region of relatively low literacy 76. In this case, the region of relatively low literacy 76 is Libya where a percentage of the adult population unable to read or write is fifty to seventy-five percent.

Referring now to FIG. 7, a world map depicting income level by region 80 is shown. As depicted, a region of high income level 82 is shown. In this case, a region of high income level 82 is the United States of America where the Gross National Product per capita exceeds four hundred percent. Also depicted in FIG. 9 is a region of moderately high income level 84. In this case the region of moderately high income level 84 is Libya where the Gross National Product per capita is two hundred to four hundred percent. Also shown is a region of low income level 86. In this case, the region of low income level 86 is the Philippines where the Gross National Product per capita is under twenty-five percent. As may be readily appreciated, selecting a live agent by the method depicted in FIG. 7 taking into account literacy as a desirable skill, literacy rate as indicative of skill level, and level of income as correlating to cost of labor, a selection of a live agent 12 (FIG. 1) in the Philippines is likely to result. Similarly, a live agent 12 (FIG. 1) of Lybia is not likely to result. In a preferred embodiment, fluency in the English language is also a desirable skill. High likelihood of fluency in the English language among people in the Philippines and especially in its capital city, Manila, further points to selection of a live agent in Manila, the Philippines by the method according to FIG. 7. Other skills to be considered may include the ability to type, particularly where the Internet based system designer with live agent assist establishes mutual communication 32 (FIG. 1) using a digital data link.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An internet based system designer, the system designer comprising:
a configurator tool providing a range of relationships for correlating selections within a scope of a configuration; and
a common reference frame in communication with said configurator tool, whereby a user of the configurator tool and a live agent simultaneously view at least one common page,
wherein the live agent assists the user.

2. The system designer of claim 1, wherein the configurator tool comprises an expert system and the live agent assists the user by helping the user to perform at least one of navigation of the expert system and use of the expert system.

3. The system designer of claim 1, wherein the user and the live agent establish mutual communication.

4. The system designer of claim 3, wherein the user and the live agent simultaneously view the common page while maintaining mutual communication.

5. The system designer of claim 3, wherein the mutual communication occurs by at least one of telephone, digital video link, digital audio link, online instant messaging system, and internet chat technology.

6. The system designer of claim 1, wherein the selections are preselected for configuration.

7. The system designer of claim 1, wherein a relationship within the domain of relationships involves at least in part at least one algorithmic function.

8. The system designer of claim 1, wherein the live agent assists the user in modification of at least one of a selection, a relationship, the configuration, the configurator tool, the mutual communication, the common reference frame, and the common page.

9. The system designer of claim 8, wherein the modification of the configuration includes at least one of expansion, limitation, and redefinition of a scope of the configuration.

10. The system designer of claim 9, wherein the expansion of a scope of the configuration includes live agent assistance with multiple configurator tools.

11. The system designer of claim 1, wherein the common reference frame permits the live agent to view a user interface that looks the same as the user interface of the user.

12. The system designer of claim 1, wherein the live agent is chosen by an agent selection method comprising:
determining at least one desirable skill required of a live agent;
determining an appropriate level of skill required of a live agent;
evaluating the cost of labor for at least one live agent; and
selecting a live agent based at least in part on the cost of labor for a live agent with the appropriate level of skill regarding the desirable skill.

13. A method of providing live agent assistance for an internet based system designer, the method comprising:
providing a configurator tool to a user permitting the user to assemble a configuration of selections, wherein the configuration includes at least two selections and a relationship correlating the selections; and
establishing a common reference frame between the user and a live agent, wherein the user and the live agent simultaneously view at least one common page,
wherein the live agent assists the user.

14. The method of claim 13, wherein the configurator tool comprises an expert system and the live agent assists the user by helping the user to perform at least one of navigation of the expert system and use of the expert system.

15. The method of claim 13, further comprising the step of establishing mutual communication between the user and the live agent.

16. The method of claim 15, wherein the user and the live agent simultaneously view the common page while maintaining mutual communication.

17. The method of claim 15, wherein the mutual communication occurs by at least one of telephone, digital video link, digital audio link, online instant messaging system, and internet chat technology.

18. The method of claim 13, wherein the selections are preselected for configuration.

19. The method of claim 13, wherein the relationship involves at least in part at least one algorithmic function.

20. The method of claim 13, wherein the live agent assists the user in modification of at least one of a selection, a relationship, the configuration, the configurator tool, the mutual communication, the common reference frame, and the common page.

21. The method of claim 20, wherein the modification of the configuration includes at least one of expansion, limitation, and redefinition of a scope of the configuration.

22. The system designer of claim 21, wherein the expansion of a scope of the configuration includes live agent assistance with multiple configurator tools.

23. The method of claim 13, wherein the common reference frame permits the live agent to view a user interface that looks the same as the user interface of the user.

24. The method of claim 13, wherein the live agent is chosen by an agent selection method comprising:
determining at least one desirable skill required of a live agent;
determining an appropriate level of skill required of a live agent;
evaluating the cost of labor for at least one live agent; and
selecting a live agent based at least in part on the cost of labor for a live agent with the appropriate level of skill regarding the desirable skill.
